(19) United States
(12) Patent Application Publication
(10) Pub. No.: US 2026/0275036 A1
(43) Pub. Date: Sep. 17, 2026

(54) POLYURETHANE BUILDING BLOCK CONTAINING AMIDE AND URETHANE BONDS

(71) Applicant: CARGILL, INCORPORATED, Wayzata, MN (US)

(72) Inventors: Wilhelmus Adrianus Jacobus Honcoop, Bergambacht (NL); Johannes Hendrik Lexmond, Moordrecht (NL)

(73) Assignee: CARGILL, INCORPORATED, Wayzata, MN (US)

(21) Appl. No.: 19/167,416

(22) PCT Filed: Mar. 20, 2024
(86) PCT No.: PCT/US2024/020793

§ 371 Date: Sep. 22, 2025

Related U.S. Application Data
(60) Provisional application No. 63/492,658, filed on Mar. 28, 2023.

(51) Int. Cl. C08G 69/48; C08G 18/60; C09D 175/12; C09J 175/12

(52) U.S. Cl. CPC C08G 69/48; C08G 18/603; C09D 175/12; C09J 175/12; C08G 2150/00; C08G 2170/00; C08G 2190/00

(57) ABSTRACT

The present disclosure relates to polyurethane polymers manufactured by using the hydroxyl functional amide/urethane containing polyol of Formula 1:

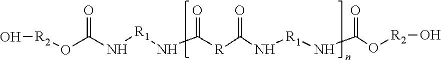

wherein:
R is an alkyl chain of 4 to 44 carbon atoms;
R₁ is an alkyl chain of 2 to 44 carbon atoms;
R₂ is an alkyl chain of 1 to 10 carbon atoms; and
n has a value from 1 to 10, more particularly from 1 to 7, more particularly from 1 to 4.

### CROSS-REFERENCE TO RELATED APPLICATIONS

This application claims the benefit of U.S. Provisional Application No. 63/492,658, filed Mar. 28, 2023, which is incorporated by reference herein in its entirety.

### TECHNICAL FIELD

The present invention relates to a polyol, a polyurethane comprising the polyol, the use of the polyol and a method of making the polyurethane. The present invention seeks to provide an improved polyol which may be used in making a polyurethane so that one or more properties (e.g., physical properties) of the polyurethane are improved. The improved properties are derived through the cooperation of hydrolytically stable bonds like urethane and amide bonds. These improved properties may include one or more of hardness, tensile strength, elongation, adhesion, chemical and hydrolytic resistance or an improvement or a combination thereof.

### BACKGROUND

The polyol of the present invention may be used in making polyurethanes. Polyurethanes are extremely versatile materials and have been used in a wide variety of applications such as foam insulation, car seats, paint coatings, adhesives, sealants, elastomers and abrasion resistant coatings.

Polyurethanes are also used in a wide variety of forms, for example non-cellular materials such as elastomers, and cellular materials such as low density flexible foams, high density flexible foams, and microcellular foams. Polyurethanes, both in dispersion and non-dispersion forms, are also known to find use in adhesives, for example in deployment in the furniture and automotive industries.

Polyurethane dispersions are used in paint coating compositions. Such coating compositions provide surface protective and/or decorative coatings which may be applied to substrates and allowed to dry or cure to form continuous protective and decorative films. Such coatings may be applied to a wide variety of substrates including metals, wood, plastics, and plaster. Important properties of the formed film include hardness and resistance to water.

Polyurethane dispersion polymers are an important class of binders for aqueous coating compositions, as they produce excellent properties, such as chemical and stain resistance, hardness and toughness in the solid coating.

Polyurethane elastomers are used in cabling, tubing, belting, sportswear (e.g., sports shoes, goggles, ski boots), films/sheets, automotive interior (e.g., grips, armrests, consoles).

Polyurethanes, both in dispersion and non-dispersion forms, are also known to find use in adhesives, for example in hotmelt, moisture cured and 2-componant adhesives. Hotmelt adhesives are adhesives which are solid at room temperature and which can be applied in the form of a melt, usually at temperatures in the range from 80 to 250° C. Moisture-curing and 2 component adhesives may also be employed. Polyurethane adhesives can be used to adhere a wide range of materials, such as polar substrates like paper, wood, and metal as well as less polar substrates such as polymers and plastics.

There is a constant need for polyurethanes to have improved and/or specialized properties such as increased strength, hardness, rigidity, crystallinity, UV-stability, color stability, chemical resistance, and/or moisture resistance.

A polyurethane may be made by reacting an isocyanate with a polyol. The polyol may comprise one or more ester bonds (e.g., an oligoester or a polyester), one or more ether bonds (e.g., an oligoether or a polyether) or the polyol may comprise both ester and ether bonds.

### SUMMARY

The present invention is based in part on the recognition that the use of a linear or branched diacid or diamine residue having 6 to 44 carbon atoms in combination with a dimer fatty residue in a polyol may provide the polyol with improved properties which balance flexibility and chemical/hydrolysis resistance with increased hardness or tensile strength. Without being bound by theory, it is believed that the dimer fatty residue may provide the flexibility and chemical/hydrolysis resistance due to its amorphous and hydrophobic nature and the linear or branched diacid or diamine residue comprising 6 to 44 carbon atoms may provide the improved hydrolytic stability and chemical resistance due to the chemical amide and urethane bonds.

### DETAILED DESCRIPTION

The term ‘dimer fatty residue’ as used herein, unless otherwise defined, refers to a residue of a dimer fatty acid (also referred to as a dimer fatty diacid) or a residue of a dimer fatty diacid derivative such as a dimer fatty diol or dimer fatty diamine.

Unless specifically indicated otherwise, all percentage reported herein are intended to be percentages by weight of the final composition referenced (i.e., wt %).

The term ‘functionality’ as used herein with regard to a molecule or part of a molecule refers to the number of functional groups in that molecule or part of a molecule. A ‘functional group’ refers to a group in a molecule which may take part in a chemical reaction, e.g., a carboxylic acid group, a hydroxyl group and an amine group are all examples of functional groups. For example, a diacid (with two carboxylic acid groups) and a diol (with two hydroxyl groups) both have a functionality of 2 and a triacid and triol both have a functionality of 3.

The polyols of the present disclosure are derived from the condensation of a diacid and diamine followed by the reaction of the resulting product with a cyclic carbonate to create a polyol.

The term ‘dimer fatty acid’ (also referred to as dimer fatty diacid) is well known in the art, and refers to the dimerization products of mono- or polyunsaturated fatty acids and/or esters thereof. The related term trimer fatty acid similarly refers to trimerisation products of mono- or polyunsaturated fatty acids and/or esters thereof.

Dimer fatty acids are described in T. E. Breuer, ‘Dimer Acids’, in J. I. Kroschwitz (ed.), Kirk-Othmer Encyclopedia of Chemical Technology, 4th Ed., Wily, New York, 1993, Vol. 8, pp. 223-237. They are prepared by polymerizing fatty acids under pressure, and then removing most of the unreacted fatty acid starting materials by distillation. The final product usually contains some small amounts of mono fatty acid and trimer fatty acids but is mostly made up of dimer fatty acids. The resultant product can be prepared with various proportions of the different fatty acids as desired.

The ratio of dimer fatty acids to trimer fatty acids can be varied, by modifying the processing conditions and/or the unsaturated fatty acid feedstock. The dimer fatty acid may be isolated in substantially pure form from the product mixture, using purification techniques known in the art, or alternatively a mixture of dimer fatty acid and trimer fatty acid may be employed.

In some aspects, the dimer fatty acids or dimer fatty residues used in the present invention are preferably derived from the dimerization products of C10 to C30 fatty acids; in other aspects from C12 to C24 fatty acids, in other aspects from C14 to C22 fatty acids, in other aspects from C16 to C20 fatty acids, and in other aspects from C18 fatty acids. Thus, the resulting dimer fatty acids may comprise between 20 to 60 carbons, in other aspects from 24 to 48 carbons, in other aspects from 28 to 44 carbons, in other aspects from 32 to 40 carbons, and in other aspects 36 carbon atoms.

The fatty acids, from which the dimer fatty acids are derived, may be selected from linear or branched unsaturated fatty acids. The unsaturated fatty acids may be selected from fatty acids having either a cis or trans configuration and may have one or more than one unsaturated double bonds.

In some aspects, the fatty acids used are linear mono-unsaturated fatty acids.

The dimer fatty acids may be hydrogenated. The dimer fatty acids may be non-hydrogenated. A hydrogenated dimer fatty residue (from a diacid, diol or diamine) may have better oxidative or thermal stability which may be desirable in a polyurethane formed from the co-polymer polyol.

As used herein, the term “hydrogenated” or “hydrogenated dimer acid” refers to partial, complete, or substantially complete hydrogenation of the dimer acid. Partial or substantially complete hydrogenation of natural oils and fatty acids is well known in the art. A skilled artisan will appreciate that is difficult and impractical to completely hydrogenate a natural oil or fatty acid as some unsaturation will most likely remain in any hydrogenated oil no matter the lengths taken during hydrogenation. Efforts to completely hydrogenate an oil or fatty acid will lead to economic inefficiencies and degradation of the product. The extent of hydrogenation is typically reflected by reference to the products' residual iodine value. Therefore, many oils sold or referred to as “fully” hydrogenated have been processed to this point of diminishing returns and still have a small residual iodine value. Likewise, hydrogenation of dimer fatty acid may in some cases yield a product with a residual iodine value.

Suitable dimer fatty acids may be derived from (i.e., are the dimer equivalents of) the dimerization products of oleic acid, linoleic acid, linolenic acid, palmitoleic acid, or elaidic acid. In some aspects, suitable dimer fatty acids are derived from oleic acid.

The dimer fatty acids may be dimerization products of unsaturated fatty acid mixtures obtained from the hydrolysis of natural fats and oils, e.g., sunflower oil, soybean oil, olive oil, rapeseed oil, cottonseed oil, or tall oil.

The molecular weight (weight average) of the dimer fatty acid may be in the range from 450 to 690, in some aspects 500 to 640, in some aspects 530 to 610, and in some aspects 550 to 590. Average molecular weight may be determined by methods known in the art.

In addition to the dimer fatty acids, dimerization usually results in varying amounts of trimer fatty acids (so-called “trimer”), oligomeric fatty acids, and residues of monomeric fatty acids (so-called “monomer”), or esters thereof, being present. The amount of monomer can, for example, be reduced by distillation.

Similarly, the optional trimer fatty acids may be derived from the trimerization products of the materials mentioned with regard to the dimer fatty acids, and in some aspects are trimers of C10 to C30, in some aspects trimers are C12 to C24, in some aspects trimers are C14 to C22, further in some aspects trimers are C16 to C20 fatty acids, and in some aspects are C18 fatty acids. Thus, the trimer fatty acids may contain in the range from 30 to 90 carbons, in some aspects from 36 to 72 carbons, in some aspects from 42 to 66 carbons, in some aspects from 48 to 60 carbons, and in some aspects 54 carbon atoms.

The molecular weight (weight average) of the trimer fatty triacids may be in the range from 750 to 950, in some aspects from 790 to 910, in some aspects from 810 to 890, and in some aspects from 830 to 870.

The dimer fatty acid used in the present invention may have a dimer fatty acid (or dimer) content of greater than 60 wt. %, in some aspects greater than 70 wt. %, in some aspects greater than 80 wt. %, and in some aspects greater than 85 wt. %. In some aspects, the dimer content of the dimer fatty acid is in the range from 90 wt. % to 99 wt. %. In some aspects, the dimer fatty acid preferably has a dimer fatty acid (or dimer) content in the range from 70 wt. % to 96 wt. %.

In addition, particularly preferred dimer fatty acids may have a trimer fatty acid (or trimer) content of less than 40 wt. %, in some aspects less than 30 wt. %, in some aspects less than 20 wt. %, and in some aspects less than 15 wt. %. In some aspects he trimer fatty acid content may be less than 1 wt. %.

Furthermore, the dimer fatty acid preferably comprises less than 10 wt. %, in some aspects less than 6 wt. %, in some aspects less than 4 wt. %, and in some aspects less than 3.5 wt. % of mono fatty monoacid (or monomer).

All of the above weight percentage values are based on the total weight of polymerised fatty acids and mono fatty acids present.

A dimer fatty diacid (or dimer fatty acid) may be converted to a dimer fatty diamine as is known in the art. A dimer fatty diamine may have the same structural properties as described herein with regard to a dimer fatty diacid (or dimer fatty acid) except that the acid groups in the dimer fatty diacid are replaced with amine groups in the dimer fatty diamine. In a similar manner, a trimer fatty triacid may be converted to a trimer fatty triamine which may have properties as described herein with regard to a trimer fatty triacid.

The dimer fatty diamine may be hydrogenated. The dimer fatty diamine may be non-hydrogenated.

### Hydroxyl Functional Amide/Urethane Containing Polyol

The hydroxyl functional amide/urethane containing polyol is shown in Formula 1:

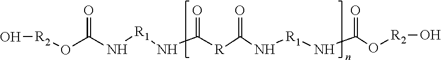

wherein:
R is an alkyl chain of 4 to 44 carbon atoms;
R₁ is an alkyl chain of 2 to 44 carbon atoms;
R₂ is an alkyl chain of 1 to 10 carbon atoms; and
n has a value from 1 to 10, more particularly from 1 to 7, more particularly from 1 to 4.

The polyols of the present disclosure are prepared in a two step process. In the first step a mixture of a diacid and a diamine (or a mixture of diacids and diamines) are combined and reacted to form mixture of amides or 1 amides described in Formula 2 below.

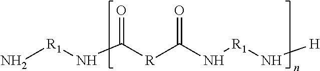

wherein:
R is an alkyl chain of 4 to 44 carbon atoms;
R₁ is an alkyl chain of 2 to 44 carbon atoms; and
n has a value from 1 to 10, more particularly from 1 to 7, more particularly from 1 to 4.

The term “alkyl” as used herein means a saturated or unsaturated, branched, or straight-chain divalent hydrocarbon radical derived by the removal of two hydrogen atoms from the carbon atoms of a parent alkane, alkene, or alkyne. In some aspects one or more of the alkyl groups are substantially saturated. In some aspects, one or more of the alkyl groups are fully or partially saturated.

In some aspects alkyl groups may be branched. In other aspects, alkyl groups may be unbranched or alternatively referred to as straight chain alkyl groups.

Techniques for the formation of amides and polyamides of Formula 2 are well known to the skilled artisan. Typically, the acid and amine reactants are heated to elevated temperature. Upon reaction the water byproduct is removed by virtue of the elevated temperature. For example, the diacid and diamine (or mixture of diacid and/or diamine) may be heated to temperature to 200° C.-230° C., under normal pressure and in a nitrogen atmosphere. The reaction is allowed to proceed until a desired acid value is obtained. Typically, acid value less than 2 or less than 1 is utilized as an endpoint. Alternatively, the condensation reaction could be preformed with the assistance of a catalyst or under reduced pressure but need not necessarily be run in that fashion.

The diacid contains an R group comprising and alkyl chain of from 6 to 44 carbons. The diacid may be a dimer diacid or a commercially available diacid. The R group alkyl chain may be straight or branched. In some aspects, R is straight alkyl chain of 6 to 40 carbons. The R group may be a mixture of alkyl chains. In some aspects, the R group is a mixture of 7 carbon straight alky chains and 34 carbon straight alkyl chains. The R group may be derived from a mixture of diacids.

The diamine contains an R₁ group. The diacid contains an R₁ group comprising and alkyl chain of from 6 to 44 carbons. The diamine may be a dimer diamine or a commercially available diamine. The R₁ group alkyl chain may be straight or branched. In some aspects, R₁ is straight alkyl chain of 6 to 40 carbons. The R₁ group may be a mixture of alkyl chains. In some aspects, the R₁ group is a mixture alky chains including 34 carbon straight alkyl chains.

The compounds of Formula 2 are then reacted to form the compounds of Formula 1. For example, the terminal amine groups of Formula 2 may be reacted with a cyclic carbonate such as ethylene carbonate or propylene carbonate. This type of ring opening reaction is well known the art. For examples, directly after the condensation described above the reaction temperature may be lowered to approximately 100° C., charged with the cyclic carbonate, and the allowed to proceed to an amine value of less than 10.

In some aspects, the Compounds of Formula 1 are those wherein R₂ is alkyl chain with 2 to 4 carbons.

The compounds of Formula 1 may then be isolated from the reactor after cooling. They be utilized directly or may be purified by methods known in the art.

The weight ratio of diacid to diamine in the polyol may be in the range 90:10 to 30:70, preferably in the range 85:15 to 45:55.

The weight % of diamine in the polyol may be greater than the weight % of diacid.

These relative amounts of diacid and diamine in the polyol may provide an advantageous balance of flexibility, tensile strength, hardness and hydrolysis resistance in a polyurethane formed from the polyol as will be discussed in further detail herein.

In some aspects, the polyol may have a molecular weight (weight average) of at least 500, or at least 800, or at least 1000, or at least 1500, or at least 1800.

### Polyurethanes

Another aspect of the present disclosure is a polyurethane comprising a polyol as described herein.

The composition comprising a mixture of the polyol and isocyanate may be considered to be a “pre-polymer” and is conveniently referred to as such in this description. Such a pre-polymer may be produced by efficiently mixing a polyol with an isocyanate. The pre-polymer may subsequently react to form a polyurethane, the reaction may be instigated via any suitable means, for example, by curing via elevated temperature, or by introduction of an initiator catalyst. In some aspects, the polyol and isocyanate may be reacted (cured) at an elevated temperature, and said elevated temperature may be in the range from 50° C. to 80° C., or in other aspects, in the range from 60° C. to 75° C. In the reacted polyurethane polymer composition, the isocyanate to polyol (NCO/OH) ratio employed is preferably in the range from 1 to 1.2:1, more preferably 1 to 1.1:1., and particularly 1 to 1.03:1.

In some aspects, the polymer composition may have an isocyanate content (measured in accordance with ASTM 2572) in the range from 5 wt % to 30 wt %, or from 10 wt % to 23 wt %, or from 15 wt % to 20 wt %, or from 18 wt % to 19 wt % NCO.

The isocyanate, in some aspects, comprises at least one isocyanate which has a functionality of at least 2.

The isocyanate may be an aliphatic isocyanate, cycloaliphatic or an aromatic isocyanate. In some aspects, the isocyanate is preferably an aliphatic isocyanate. However, in some alternative aspects preferably, the isocyanate may be an aromatic isocyanate. An aliphatic isocyanate is often utilized when the polymer composition is intended to be a polymer substrate in the form of a coating composition, and an aromatic isocyanate is often utilized when the polymer composition is intended to be used in making a polymer substrate in the form of a polyurethane elastomer; this is because an aromatic isocyanate may provide improved rigidity or strength to the elastomer due to its aromatic structure when compared with an aliphatic isocyanate.

Suitably, the pre-polymer composition may comprise an isocyanate selected from one or more of an isocyanate, a polyisocyanate, a diisocyanate, or a triisocyante. The polyisocyanate may be selected from aliphatic polyisocyanates and hydrophilic polyisocyanates. The isocyanate monomers may be used alone or as mixtures thereof. In some aspects, the isocyanate is a diisocyanate.

Suitably, the polyisocyanate may be selected from one or more of the following; hexamethylene 1,6-diisocyanate, isophorone diisocyanate (IPDI) ethylene diisocyanate, 1,2-diisocyanatopropane, 1,3-diisocyanatopropane, 1,6-diisocyanatohexane, 1,4-butylene diisocyanate, lysine diisocyanate, hexamethylene diisocyanate (HDI), 1,4-methylene bis-(cyclohexylisocyanate) and isophorone diisocyanate., from toluene diisocyanate, m-phenylene diisocyanate, p-phenylene diisocyanate, xylylene diisocyanate, 4,4′-diphenylmethane diisocyanate, polymethylenepolyphenyl diisocyanate, 3,3′-dimethyl-4,4′-biphenylene diisocyanate, 3,3′-dimethyl-4,4′-diphenylmethane diisocyanate, 3,3-dichloro-4,4′-biphenylene diisocyanate, 1,5-naphthalene diisocyanate, or modified compounds thereof. Commercial examples of suitable polyisocyanates include Desmodur® N7300, N3300, N3900, N3600, N3390 and Tolonate™ HDB, HDT-LV.

As such, suitable aromatic isocyanates may be selected from one or more of the following: toluene diisocyanate, m-phenylene diisocyanate, p-phenylene diisocyanate, xylylene diisocyanate, 4,4′-diphenylmethane diisocyanate, polymethylenepolyphenyl diisocyanate, 3,3′-dimethyl-4,4′-biphenylene diisocyanate, 3,3′-dimethyl-4,4′-diphenylmethane diisocyanate, 3,3-dichloro-4,4′-biphenylene diisocyanate, 1,5-naphthalene diisocyanate, or modified compounds thereof, and uretonimine-modified compounds thereof may be particularly preferred.

Aliphatic polyisocyanates may be preferred, particularly hexamethylene diisocyanate and/or isophorone diisocyanate, and this embodiment is especially preferred when the polymer composition is to be used to provide a coating composition.

Additionally, or alternatively, 4,4′-diphenylmethane diisocyanate (MDI) is utilized in one aspect of the invention. In another aspect, (MDI) is used alone, and in a further aspect a mixture of MDI and a uretonimine-modified 4,4′-diphenylmethane diisocyanate (modified MDI) is employed, such as uretonimine-modified compounds thereof. This aspect may be utilized when the polymer composition is to be used to provide a polymer substrate in the form of an elastomer or adhesive.

Also suitable for use are the biurets, alophonates and/or isocyanurates of such aliphatic or aromatic polyisocyanates. In some aspects, biurets and isocyanurate of polyisocyanates are utilized, particularly aliphatic polyisocyanates such as hexamethylene diisocyanate and isophorone diisocyanate. In some aspects, biurets and isocyanurates of hexamethylene diisocyanate are used. This aspect is utilized when the polymer composition is intended to be provided as polymer substrate in the form of a coating, and more particularly specialty coatings may utilize biurets and isocyanurates.

In accordance with a further aspect of the present disclosure there is provided a pre-polymer composition comprising the polyol of Formula 1 as described above.

The pre-polymer composition comprising the polyamide urethane diol may preferably be incorporated into a more complex resin or binder system. In this case the pre-polymer composition of the present invention is further mixed and/or reacted with one or more additional polymer components, and these additional polymer ingredients may be present as the majority part of the resin or binder system. In this aspect of the present invention is it convenient to refer to the additional polymer ingredients as a binder polymer ingredients. As such the pre-polymer composition may comprise a binder polymer ingredients, and the binder polymer ingredients is preferably the major component of the pre-polymer composition: that is to say that the pre-polymer composition comprises a greater amount of the binder polymer ingredients than another individual component of the pre-polymer composition.

In other aspects, the pre-polymer composition may further comprise a chain extender. This may be particularly desirable when the polymer composition is a polyurethane. The chain extender may be in the form of a chain extender composition. The chain extender composition is maybe prepared by simple pre-mixing of, for example, the chain extender and other additives (such as blowing agent, and/or urethane catalyst, and/or pigment and/or filler and/or blowing agent).

The chain extender, or chain extender composition, used to form the polyurethane may comprise a low molecular compound having two or more active hydroxyl groups, for example polyols such as ethylene glycol, diethylene glycol, propylene glycol, 1,4-butylene glycol, 1,5-pentylene glycol, methylpentanediol, isosorbide (and other iso-hexides), 1,6-hexylene glycol, neopentyl glycol, trimethylolpropane, hydroquinone ether alkoxylate, resorcinol ether alkoxylate, glycerol, pentaerythritol, diglycerol, dextrose, and dimer fatty diol. Chain extenders may also include aliphatic polyhydric amines such as ethylenediamine, hexamethylenediamine, and isophorone diamine; aromatic polyhydric amines such as methylene-bis(2-chloroaniline), methylenebis(dipropylaniline), diethyl-toluenediamine, trimethylene glycol di-p-aminobenzoate; alkanolamines such as diethanolamine, triethanolamine, and diisopropanolamine.

In one aspect of the invention, the chain extender is a polyol, in some aspects a diol, particularly having an aliphatic linear carbon chain comprising in the range from 1 to 10, or 3 to 5 carbon atoms. In some aspects, diols include ethylene glycol, propylene glycol, 1,4-butylene glycol, and 1,5-pentylene glycol.

The molar ratio of chain extender to total other polyol present in the polymer composition may be in the range from 1 to 10:1, or 1.5 to 8:1, or 2 to 5:1, or 2.5 to 4:1.

In some aspects, the pre-polymer composition may comprise one or more optional additives. These additives may be selected from pigments, dyes, rheology modifiers, blowing agents, fillers, catalysts, stabilisers, emulsifiers, dispersants, other surfactants, and mixtures thereof. The optional additives may be present in addition to the binder polymer ingredient described above and may be selected by the skilled person dependent upon the intended final use or product to be produced by the polymer composition being prepared.

A pigment additive may be organic or inorganic. Examples of organic pigments include but are not limited to azo pigments, phthalocyanine, quinacridone. Examples of inorganic pigments are iron oxide pigments, titanium dioxide and carbon black.

Examples of dyes include but are not limited azo, azine, anthraquinone, acridine, cyanine, oxazine, polymethine, thiazine and triarylmethane dyes. These dyes may be employed as basic or cationic dyes, metal complex, reactive, acid, sulphur, coupling or substantive dyes.

Suitable blowing agents include water, and fluorocarbons such as trichlorofluoromethane, dichlorodifluoromethane and trichlorodifluoroethane. The blowing agents may be used alone or as mixtures thereof. Blowing agents are often used where the polymer composition is intended as an elastomer.

Suitable catalysts for polymerization include known polyurethane catalysts, which will facilitate reaction of an isocyanate and a polyol to form a polyurethane; examples include compounds of divalent and tetravalent tin, more particularly the dicarboxylates of divalent tin and the dialkyl tin dicarboxylates and dialkoxylates. Specific examples include but are not limited to dibutyl tin dilaurate, dibutyl tin diacetate, dioctyl tin diacetate, dibutyl tin maleate, tin(II) octoate, tin(II) phenolate, and the acetyl acetonates of divalent and tetravalent tin. In addition, tertiary amines or amidines may also be employed, either alone or in combination with the aforementioned tin compounds. Examples of suitable amines include but are not limited to tetramethyl butane diamine, bis-(dimethylaminoethyl)-ether, 1,4-diazabicyclooctane (DABCO), 1,8-diazabicyclo-(5.4.0)-undecane, 2,2′-dimorpholinodiethyl ether, dimethyl piperazine, and mixtures thereof.

Suitable stabilizers include but are not limited to materials which stabilize the viscosity of the polyurethane during its production, storage and application, and include monofunctional carboxylic acid chlorides, monofunctional highly reactive isocyanates, and non-corrosive inorganic acids. Examples of such stabilizers are benzoyl chloride, toluene sulfonyl isocyanate, phosphoric acid or phosphorous acid. In addition, suitable hydrolysis stabilizers include for example the carbodiimide type. Stabilizers which are antioxidants or UV absorbers may also be used. Examples of such stabilizers are HALS hindered amine light stabilisers, hydrogen-donating antioxidants such as hindered phenols and secondary aromatic amines, benzofuranone, oxanilides, benzophenones, benzotriazoles and UV absorbing pigments.

Suitable surfactants include silicone surfactants such as dimethylpolysiloxane, polyoxyalkylene polyol-modified dimethylpolysiloxane and alkylene glycol-modified dimethylpolysiloxane; and anionic surfactants such as fatty acid salts, sulphuric acid ester salts, phosphoric acid ester salts and sulphonates.

In some aspects, the polymer composition is provided as a two component (2K) polyurethane resin system. This is particularly preferred where the polymer composition is to be utilized to produce a coating composition. In said 2K polyurethane system, the polyamide urethane diol of the present invention and a binder polymer may provide the first component of the resin system and a polyisocyanate may provide the second component of the resin system. In this embodiment one or more optional additives may be provided in either the first or second component. Such a 2K system is particular preferred for the preparation of coatings comprising or consisting of the polymer composition. As such, the present invention may preferably provide a coating composition comprising a polymer composition as described herein, and hence comprising the polyamide urethane diol and polyisocyanate, as described above.

An aspect of the present disclosure also provides a polymer substrate that is a coating, adhesive, sealant or elastomer comprising the polyol of Formula 1.

As such, in accordance with a one aspect of the present disclosure there is provided a coating comprising a polyamide urethane diol as described above, or a polymer composition as described above. The coating may comprise more than one polyisocyanate, in some aspects 2 or 3, in other aspects 2, as described above in relation to the polymer composition. Suitable polyisocyanates may be selected from those described above in relation to the polymer composition.

The coating may comprise at least 1 wt % polyisocyanate, preferably at least 2 wt %, particularly at least 5 wt %, desirably at least 10 wt %, all based on the total weight of the coating composition. The coating may comprise at most 50 wt % polyisocyanate, preferably at most 40 wt %, particularly at most 30 wt %, all based on the total weight of the coating.

The molar ratio of free isocyanate groups to free hydroxyl groups in the solids part of the coating composition prior to curing (NCO/OH ratio) may be at least 0.7, preferably at least 0.8, more preferably at least 0.9, particularly at least 1. The NCO/OH ratio may be at most 3, preferably at most 2.5, more preferably at most 2, particularly at most 1.8. A higher NCO/OH ratio may provide improved hardness and/or chemical resistance to a cured coating.

The coating may have a total solids content, according to DIN EN ISO 3251 of at least 25 wt %, preferably at least 30 wt %, more preferably at least 35 wt %, particularly at least 40 wt %, based on the total weight of the coating composition. The coating may have a total solids content of at most 80 wt %, preferably at most 70 wt %, more preferably at most 65 wt %, particularly at most 60 wt %, based on the total weight of the coating.

The coating may comprise at least 10 wt % water, preferably at least 20 wt % water, particularly at least 30 wt % water, all based on the total weight of the coating. The coating may comprise at most 90 wt % water, preferably at most 80 wt % water, particularly at most 70 wt % water, all based on the total weight of the coating composition.

The coating may preferably comprise one or more additional ingredients, especially a colorant additive for example a pigment and/or dye.

The coating may be a clearcoat. The coating may be transparent or substantially transparent, in one aspect the coating composition is transparent. The coating may not comprise a colorant additive for example it may not comprise a pigment and/or dye.

A coating according to the present invention may be applied to a substrate (that is a substrate which is distinct to the polymer substrate of the present invention). Application of the coating to a substrate may be provided by any number of techniques including spray, brush, roller, paint mitt, and others as known in the art. Numerous substrates are suitable for application of the coating composition. The substrate may be selected from metal, particularly steel and aluminum, wood, brick, concrete, and plastic. The substrate may be an exterior wall, interior wall or floor.

Suitably, the coating may be applied as a primer coating on the substrate. A further coating layer such as an overcoat or topcoat may be applied on top of the primer coating. Additionally, or alternatively, the present coating composition may be applied as a topcoat. The coating may be provided as a paint or lacquer.

Additionally, or alternatively, in accordance with an aspect of the present disclosure there is provided an elastomer comprising a polyamide urethane diol as described above, or a polymer composition as described above. An elastomer is a polymer which exhibits elasticity i.e., a tendency to return to its original shape after being deformed. Polyurethane elastomers are used in many applications including cabling, tubing, belting, films/sheets (e.g., as flooring) and automotive interiors (e.g., grips, armrests, consoles). The elastomer may be provide as a sheet (e.g., for flooring or other surface covering) or an automotive interior.

The polyurethane elastomer may be a solid elastomer or a microcellular elastomer. The elastomer may be a reinforced elastomer. The reinforced elastomer may comprise reinforcing fibers or fibre mats. The reinforcing fibres may comprise glass fibres, carbon fibres or polyester fibers.

The polyurethane elastomer may have a tensile strength at break measured according to ISO 37 norm of at least 1 MPa, preferably at least 5 MPa, more preferably at least 10 MPa. The tensile strength measured according to ISO 37 norm is a standard measurement which measures a standard elastomer sample.

The polyurethane elastomer may have a (maximum) elongation according to ISO37-2 of at least 50%, preferably at least 150%, more preferably at least 450%. The elastomer may have a (maximum) elongation of at most 500%.

All of the features described herein may be combined with any of the above aspects, in any combination.

### EXAMPLES

The invention is illustrated by the following non-limiting examples.

It will be understood that all test procedures and physical parameters described herein have been determined at atmospheric pressure, room temperature (i.e., about 20° C.) and a relative humidity of 50% unless otherwise stated herein, or unless otherwise stated in the referenced test methods and procedures. All parts and percentages are given by weight unless otherwise stated.

### Materials Used in the Examples are Identified as Follows:

| Material Name and/or identifier | Source |
|---|---|
| Desmodur N3900 - polyisocyanate | Covestro |
| 1,4-butanediol (BDO) | BioAmber |
| MDI - 4,4-diphenylmethane diisocyanate | Covestro |
| Desmodur VK10 - polyisocyanate | Covestro |
| Adipic acid (C₆ dicarboxylic acid) | bio-based version is |
| | available from Verdezyne |
| PRIPOL 1006 (TM) dimer fatty diacid - | Cargill Incorporated |
| hydrogenated C₃₆ dicarboxylic acid | |
| PRIAMINE 1075 (TM) dimer fatty | Cargill Incorporated |
| diamine - hydrogenated C₃₆ | |
| dicarboxylic amine | |
| Dimer Diamine - hydrogenated C₄₄ | Cargill Incorporated |
| dicarboxylic amine | |
| PRIPOL 1004 (TM) dimer fatty diacid - | Cargill Incorporated |
| hydrogenated C44 dicarboxylic acid | |
| Priplast 3192 ™- polyester polyol | Cargill Incorporated |
| Crodacid 1195D (TM) - Azelaic acid | Cargill Incorporated |
| INHERENT ® C18 diacid - Saturated | Elevance |
| linear C18 dicarboxylic acid | |
| FDCA - 2,5-furan dicarboxylic acid | Avantium |
| PCD- Placcell CD220 | Daicell corporation |

### Test Methods

In this specification, the following test methods have been used:

The hydroxyl value is defined as the number of mg of potassium hydroxide equivalent to the hydroxyl content of 1 g of sample and was measured by acetylation followed by hydrolysation of excess acetic anhydride. The acetic acid formed was subsequently titrated with an ethanolic potassium hydroxide solution. Hydroxyl Value may be determined by AOCS Standard Method Cd 13-60.

The acid value is defined as the number of mg of potassium hydroxide required to neutralise the free fatty acids in 1 g of sample and was measured by direct titration with a standard potassium hydroxide solution. AV can be determined by the AOCS Official Method Ca 5a-40.

The amine value is defined as the number of mg of potassium hydroxide required to neutralise the free fatty acids in 1 g of sample and was measured by direct titration with a standard hydrochloric acid. AmV can be determined by the AOCS Official Method Ca 5a-40.

Elongation was measured using an Instron tensile tester according to ISO 37 using dumb-bell test pieces of type 2 unless otherwise specified.

Tensile Strength was measured using an Instron tensile tester according to ISO 37 using dumb-bell test pieces of type 2 unless otherwise specified.

König hardness was tested according to DIN ISO 2815.

Chemical resistance was evaluated according to DIN12720 in which coating samples were spot tested for a predetermined time and given a rating from 5=undamaged to 0=complete damage.

Lap shear testing was evaluated by using ASTM 1002.

A polyol comprising a hydroxy functional polyamide urethane diol compound of Examples 1-8 were synthesised as follows.

### Example 1

In a reactor equipped with a stirrer, a thermometer, a gas inlet, and condenser, 100 parts by weight of PRIPOL 1006 and 200 parts by weight of Priamine were charged. Subsequently, the temperature of the reactor was raised from ambient temperature to 200° C.-230° C., under normal pressure and in a nitrogen atmosphere. Under these conditions a condensation reaction was conducted until the desired acid/amine value was observed. In this example, the polyol obtained had an acid value of less than 1 mg KOH/g and an amine value of 75 mg KOH/g.

The temperature was lowered to 100° C. after which 38.3 parts of propylene carbonate (Propylene carbonate S ex BASF) was charged. A ring opening reaction was conducted until the acid-/amine-/hydroxyl value were obtained, the resulting polyol gave an acid value <1 mg KOH/g, amine value <10 mg KOH/g and a hydroxyl value of 59 mg KOH/g.

### Example 2

In a reactor equipped with a stirrer, a thermometer, a gas inlet, and condenser, 100 parts by weight of Crodacid 1195D and 600 parts by weight of Priamine 1075 were charged. Subsequently, the temperature of the reactor was raised from ambient temperature to 200° C.-230° C., under normal pressure and in a nitrogen atmosphere. Under these conditions a condensation reaction was conducted until the desired acid/amine value was observed. In this example the polyol obtained had an acid value of less than 1 mg KOH/g and an amine value of 88 mg KOH/g.

The temperature was lowered to 100° C. after which 107 parts of propylene carbonate (Propylene carbonate S ex BASF) was charged. A ring opening reaction was conducted until the acid-/amine-/hydroxyl value were obtained. The resulting polyol gave an acid value <1 mg KOH/g, amine value <10 mg KOHg and a hydroxyl value of 75 mg KOH/g.

### Example 3

In a reactor equipped with a stirrer, a thermometer, a gas inlet, and condenser, 100 parts by weight of PRIPOL 1006, 25.4 parts by weight of Adipic acid and 400 parts by weight of Priamine 1075 were charged. Subsequently, the temperature of the reactor was raised from ambient temperature to 200° C.-230° C., under normal pressure and in a nitrogen atmosphere. Under these conditions a condensation reaction was conducted until the desired acid/amine value was observed. In this example the polyol obtained had an acid value of less than 1 mg KOH/g and an amine value of 83 mg KOH/g.

The temperature was lowered to 100° C. after which 76 parts of propylene carbonate (Propylene carbonate S ex BASF) was charged. A ring opening reaction was conducted until the acid-/amine-/hydroxyl value were obtained. The resulting polyol gave an acid value <1 mg KOH/g, amine value <10 mg KOH/g and a hydroxyl value of 75 mg KOH/g.

### Example 4

In a reactor equipped with a stirrer, a thermometer, a gas inlet, and condenser, 100 parts by weight of C18 diacid and 339 parts by weight of Priamine 1075 were charged. Subsequently, the temperature of the reactor was raised from ambient temperature to 200° C.-230° C., under normal pressure and in a nitrogen atmosphere. Under these conditions a condensation reaction was conducted until the desired acid/amine value was observed. In this example the polyol obtained had an acid value of less than 1 mg KOH/g and an amine value of 81 mg KOH/g.

The temperature was lowered to 100° C. after which 60.2 parts of propylene carbonate (Propylene carbonate S ex BASF) was charged. A ring opening reaction was conducted until the acid-/amine-/hydroxyl value were obtained. The resulting polyol gave an acid value <1 mg KOH/g, amine value <10 mg KOH/g and a hydroxyl value of 65 mg KOH/g.

### Example 5

In a reactor equipped with a stirrer, a thermometer, a gas inlet, and condenser. 100 parts by weight of FDCA and 339 parts by weight of Priamine 1075 were charged. Subsequently, the temperature of the reactor was raised from ambient temperature to 200° C.-230° C. under normal pressure and in a nitrogen atmosphere. Under these conditions a condensation reaction was conducted until the desired acid/amine value was observed. In this example the polyol obtained had an acid value of less than 1 mg KOH/g and an amine value of 81 mg KOH/g.

The temperature was lowered to 100° C. after which 60.2 parts of propylene carbonate (Propylene carbonate S ex BASF) was charged. A ring opening reaction was conducted until the acid-/amine-/hydroxyl value were obtained. The resulting polyol gave an acid value <1 mg KOH/g, amine value <10 mg KOH/g and a hydroxyl value of 65 mg KOH/g.

### Example 6

In a reactor equipped with a stirrer, a thermometer, a gas inlet, and condenser. 100 parts by weight of Pripol 1004 and 167 parts by weight of Priamine 1075 were charged. Subsequently, the temperature of the reactor was raised from ambient temperature to 200° C.-230° C., under normal pressure and in a nitrogen atmosphere. Under these conditions a condensation reaction was conducted until the desired acid/amine value was observed. In this example the polyol obtained had an acid value of less than 1 mg KOH/g and an amine value of 68 mg KOH/g.

The temperature was lowered to 100° C. after which 29.2 parts of propylene carbonate (Propylene carbonate S ex BASF) was charged. A ring opening reaction was conducted until the acid-/amine-/hydroxyl value were obtained. The resulting polyol gave an acid value <1 mg KOH/g, amine value <10 mg KOH/g and a hydroxyl value of 53 mg KOH/g.

### Example 7

In a reactor equipped with a stirrer, a thermometer, a gas inlet, and condenser, 100 parts by weight of Pripol 1004 and 200 parts by weight of Dimer Diamine were charged. Subsequently, the temperature of the reactor was raised from ambient temperature to 200° C.-230° C., under normal pressure and in a nitrogen atmosphere. Under these conditions a condensation reaction was conducted until the desired acid/amine value was observed. In this example the polyol obtained had an acid value of less than 1 mg KOH/g and an amine value of 57 mg KOH/g.

The temperature was lowered to 100° C. after which 30.6 parts of propylene carbonate (Propylene carbonate S ex BASF) was charged. A ring opening reaction was conducted until the acid-/amine-/hydroxyl value were obtained, the resulting polyol gave an acid value <1 mg KOH/g, amine value <10 mg KOH/g and a hydroxyl value of 49 mg KOH/g.

### Example 8

In a reactor equipped with a stirrer, a thermometer, a gas inlet, and condenser, 27 parts by weight of Adipic acid and 200 parts by weight of Priamine 1075 were charged. Subsequently, the temperature of the reactor was raised from ambient temperature to 200° C.-230° C., under normal pressure and in a nitrogen atmosphere. Under these conditions a condensation reaction was conducted until the desired acid/amine value was observed. In this example the polyol obtained had an acid value of less than 1 mg KOH/g and an amine value of 93 mg KOH/g.

The temperature was lowered to 100° C. after which 38.5 parts of propylene carbonate (Propylene carbonate S ex BASF) was charged. A ring opening reaction was conducted until the acid-/amine-/hydroxyl value were obtained. The resulting polyol gave an acid value <1 mg KOH/g, amine value <10 mg KOH/g and a hydroxyl value of 80 mg KOH/g.

### Example 9—Polyurethane Elastomers Formed Using the Polyol of Example 1.2.3.5.6 and Example 7

As detailed in Table 2 example polyurethane elastomers (denoted as E1, E2, E3, E5, E6 and E7) were prepared using 1 part by weight of respective Polyol, 2 parts 1,4-butanediol (BDO) as a chain extender, and 3.1 parts 4,4′-5 diphenylmethane diisocyanate (MDI), using a one-shot method. To form the elastomer from the Example 1 or 2 and 1,4-butanediol (BDO) chain extender were blended and pre-heated at 50° C. and degassed in a degassing chamber. The BDO were mixed thoroughly, after which molten 4,4′-diphenylmethane diisocyanate (MDI) was added. The reaction mixture was stirred efficiently, transferred to the degassing chamber for a few minutes until significant viscosity increase occurred. The mixture was then poured into a preheated 100° C. steel mold. The mold was closed and transferred to an oven at 100° C. After 2 hours the elastomer was de-molded and further cured at 100° C. for 18 hours. As a benchmark comparison, a similar comparative reference elastomer was prepared using a commercially available polyol Priplast 3192 and PCD by the same procedure as described above.

The physical properties of each elastomer made with polyols of Ex1, Ex2, Ex3, Ex6 and Ex7 were determined and are shown in Table 2 below. The samples had properties which would render them suitable for use as elastomers or sealants.

TABLE 2
Mechanical evaluation of the unfilled elastomer

| | Elastomer Components | | | | | |
|---|---|---|---|---|---|---|
| | Control | E1 | E2 | E3 | E6 | E7 |
| Tensile strength | 8.4 | 6.9 | 13 | 12 | 14 | 5.3 |
| (MPa) | | | | | | |
| Elongation (%) | 380 | 222 | 168 | 122 | 320 | 168 |

After 1 week @90° C.

| | | | | | | |
|---|---|---|---|---|---|---|
| Retention (%) | 50 | 65 | 60 | 65 | 75 | 75 |
| Tensile strength | | | | | | |
| (MPa) | | | | | | |
| Retention (%) | 100 | 82 | 100 | 92 | 92 | 84 |
| Elongation (%) | | | | | | |

When considering the mechanical data detailed in Table 2 above when the polyamide urethane diols are included the polyurethane elastomer matrix they form polyurethane elastomer with a higher strength for Examples 2,3,6 and overall comparable elongations to the comparative reference polyurethane (PCD) elastomer materials. Additionally, it can be noted that the retention of tensile strength is improved over the reference while maintaining the elongation.

### Example 10—Polyurethane 2 Component Adhesive Formed Using the Polyol of Example 1.2.3.6 and Example 8

The polyol of Examples 1, 2, 3, 4, 6, & 8 were mixed with the Desmodur VK10L before application onto the substrate according to ASTM D1002 on a steel substrate. As a benchmark comparison, a similar comparative reference adhesive was prepared using a commercially available polyol Priplast 3192.

TABLE 3
Adhesive 2-component system in a 1:1 molar ratio
Adhesive strength (MPa)
Example

| | | | | | | Priplast 3192 |
|---|---|---|---|---|---|---|
| E1 | E2 | E3 | E4 | E6 | E8 | Reference |
| 6.4 | 5.4 | 10.8 | 11.9 | 6.6 | 9.4 | 3.4 |

When considering the mechanical data detailed in Table 3 above the polyamide urethane diols included the polyurethane adhesive system improve the adhesion on steel over the commercial Priplast 3192 which is a commercially available polyester polyol. These steel substrates are sanded and degreased according to the ASTM protocol.

### Example 11—Polyurethane 2-Component Adhesive on Oily Substrate Using the Polyol of Example 3 and Commercial Polyol

In the below table, a comparison was done as in Example 11, however the adhesive strength was compared a with preparation of the metal surface and after exposing the metal substrate to a metal working and without any subsequent degreasing to investigate the adhesion properties. The metal surfaces were exposed to a metal working oil and the excess oil simply wiped off with a towel.

TABLE 4
Adhesive 2-component system on oily steel substrate

Adhesive strength (MPa)

| Example | Priplast 3192 | E3 |
|---|---|---|
| Steel | 3.4 | 10.8 |
| Oily steel | 2 | 9 |

When considering the mechanical data detailed in Table 4 above when the polyamide urethanediol from Example 3 is included, the polyurethane adhesive system performs much better on oily steel over the commercial Priplast 3192 containing reference. The adhesive strength of the adhesive prepared from the diol of Example 3 was already higher, but it maintained 80% of the adhesive strength on oil coated steel versus only 60% for the benchmark utilizing commercial polyester polyol Priplast 3192.

### Example 12—Polyurethane Coatings Formed Using Example 1.2.3 and Commercial PCD Polyol

The polyols of Example 1,2,3 and the commercial PCD diol were incorporated into coating compositions and immediately before the application of the coating composition to the substrate, the isocyanate Desmodur N3900 was added to the formulation and mixed. Each coating composition was prepared by mixing at a OH: NCO ratio of 1:1.1. The coating composition was applied on glass as a substrate on which 120 μm films of the coating composition was applied with the aid of an applicator frame (BYK PA-2030) for the hardness and chemical resistance evaluation.

The cured coating properties were evaluated, and the results are given in Table 5, below.

TABLE 5

| | Comparative | | | |
|---|---|---|---|---|
| | PCD | Example 1 | Example 2 | Example 3 |
| König hardness (s) | 30 | 14 | 18 | 20 |

Chemical resistance: 0 = undamaged to 5 = complete damage

| | | | | |
|---|---|---|---|---|
| Acetone | 1-2 | 0 | 0 | 1 |
| Ethyl acetate | 1 | 0 | 0 | 1 |
| Acetic acid | 4 | 0 | 1 | 0 |
| 50% EtOH | 1 | 0 | 0 | 0 |
| NH₄OH | 0 | 0 | 0 | 0 |
| Water | 1-2 | 0 | 0 | 0 |

It can be seen in table that the polyamide urethane diols of the present disclosure have a slightly reduced hardness compared to the commercial Polycarbonatediol (PCD). However, advantageously the polyamide urethane diols containing coatings have an improved chemical resistance. This is particularly evident when looking at the resistance against acetic acid and water.

1. The hydroxyl functional amide/urethane containing polyol of Formula 1: 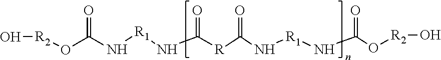
wherein:
R is an alkyl chain of 4 to 44 carbon atoms;
R₁ is an alkyl chain of 2 to 44 carbon atoms;
R₂ is an alkyl chain of 1 to 10 carbon atoms; and
n has a value from 1 to 10.

2. The polyol of claim 1, wherein R₁ is an alkyl chain of 36 to 44 carbon atoms.

3. The polyol of claim 2, wherein n is 1 to 4.

4. The polyol of claim 1, wherein the R group is derived from a mixture of diacids.

5. The polyol of claim 3, wherein R₂ is alkyl chain of 2-4 carbons.

6. A polyurethane polymer comprising the hydroxyl functional amide/urethane containing polyol of claim 1.

7. A polyurethane polymer of claim 6 that is an adhesive, coating, or sealant.

8. A method of adhering a polyurethane polymer to an oily surface comprising contacting the surface to a polyurethane polymer of claim 6.

9. A method of adhering two surfaces together comprising contacting both surfaces with a polyurethane polymer of claim 6.

10. The method of claim 9, where the surfaces are substantially oil free, oily, or a mixture thereof.

11. A polyurethane polymer comprising the hydroxyl functional amide/urethane containing polyol of claim 5.
